(19) United States
(12) Patent Application Publication
(10) Pub. No.: US 2008/0278490 A1
(43) Pub. Date: Nov. 13, 2008

(54) ANATOMICAL CONTEXT PRESENTATION

(75) Inventor: Doron Dekel, Toronto (CA)

Correspondence Address: SCHMEISER OLSEN & WATTS, 18 E UNIVERSITY DRIVE, SUITE # 101, MESA, AZ, 85201, US

(73) Assignee: CLARON TECHNOLOGY INC., Toronto (CA)

(21) Appl. No.: 12/118,274

(22) Filed: May 9, 2008

Related U.S. Application Data
(60) Provisional application No. 60/928,690, filed on May 11, 2007.

(51) Int. Cl. G06T 17/00; G06T 15/00

(52) U.S. Cl. 345/424

(57) ABSTRACT

A method of providing an image includes providing volumetric data which includes volume of interest data and volume of context data, and providing a first projection image which corresponds with the volume of interest data. A second projection image showing surfaces of objects in the volume of context data not occluded by objects shown in the first projection image is provided. A modified second projection image by adjusting the intensity and opacity of the second projection image is provided. The first and modified second projection images are combined.

### CROSS REFERENCE TO RELATED APPLICATIONS

This patent application claims priority to U.S. Provisional Application No. 60/928,690 filed on May 11, 2007, the contents of which are incorporated herein by reference.

### BACKGROUND OF THE INVENTION

1. Field of the Invention

The present invention relates generally to computer-generated images generated from medical imaging data volumes and, more particularly, to a method for presenting the spatial relationship between organs of interest and other organs and tissues surrounding them.

2. Description of the Related Art

Photo-realistic shaded volume rendering techniques (SVRT) are important for generating pseudo-3D images of objects of interest, such as bones, tissues and organs, from volumetric data acquired from patients by medical scanners, such as computed tomography (CT), magnetic resonance imaging (MRI) and ultrasound. The volumetric data is often represented as a grid of voxels. A voxel is a volume element representing properties of a small volume surrounding a location in space. In these techniques, each voxel is assigned an opacity and color, and a ray-casting process traverses the volume to simulate the effect of light being absorbed or reflected by those voxels, as projected on a virtual plane, in order to produce an image which resembles an anatomical photograph.

Another commonly used rendering technique is maximum intensity projection (MIP), wherein each pixel in the rendered image includes the brightest sample value along the corresponding virtual ray. More information regarding these imaging techniques can be found in U.S. Pat. Nos. 7,250,949, 7,301,538 and 7,333,107, the contents of all of which are incorporated herein by reference.

Often, there is a need to show the objects of interest in their anatomical context, such as in relation to surrounding objects. For example, it is useful to show liver tumors in relationship to the liver surface and liver vasculature structure. Further, it is useful to show blood vessels in relationship to nearby bones.

Showing the objects of interest in their anatomical context is typically done by either rendering the full volume in a single imaging pass and assigning low opacity to the context objects, or by rendering the data twice, once with the context objects and once without the context objects, and then blending the two images together, such as by using a weighted sum. However, these methods are only partially successful since they do not easily allow both the objects of interest and their context to be simultaneously perceived when the objects of interest are located behind the context objects.

FIG. 1 is a prior art medical image of contrast-enhanced computed tomography data of a pelvic region having a pelvic bone and blood vessels, wherein the data includes volume of interest and volume of context data. However, image 101 of FIG. 1 is cluttered and the blood vessels behind the pelvic bone are not visible. In this way, a portion of the blood vessels are occluded.

FIG. 2 is an image 102 of the blood vessels provided using a Shaded Volume Rendering Technique of the volume of interest data of image 101. The blood vessels are more visible, but there is no anatomical context because the pelvic bone cannot be seen. Accordingly, it would be useful to have a method of forming an image which allows an object of interest to be seen in its anatomical context.

### SUMMARY OF THE INVENTION

The invention employs a method of providing a projection image of volumetric data, wherein the volumetric data comprises volume of interest data and volume of context data. The method includes rendering a first projection image showing objects included in the volume of interest data and, while holding constant the projection geometry, rendering a second projection image showing the surfaces of objects included in the volume of context data but not occluded by objects shown in the first projection image. The brightness of each pixel in the second projection image is then inverted and the pixel is composited over the corresponding pixel in the first projection image using an opacity value proportional to the brightness of the pixel.

These and other features, aspects, and advantages of the present invention will become better understood with reference to the following drawings and description.

### DESCRIPTION OF THE DRAWINGS

FIG. 1 is a prior art medical image rendered from contrast-enhanced computed tomography data of a pelvic region having a pelvic bone and blood vessels, wherein the data includes volume of interest and volume of context data.

FIG. 2 is a prior art image of the blood vessels provided using a Shaded Volume Rendering Technique of the volume of interest data of the medical image of FIG. 1.

FIG. 3 is an image of the pelvic bone provided using a Shaded Volume Rendering Technique of the volume of context data of the medical image of FIG. 1.

FIG. 4 is the image of FIG. 3 with its color modified and the contribution from the volume of interest data removed.

FIG. 5 is the image of FIG. 4 after its intensity and opacity have been adjusted.

FIG. 6 is an image, in accordance with the invention, of the image of FIG. 2 combined with the image of FIG. 5.

FIG. 7 is an image of the blood vessels provided using a Maximum Intensity Projection of the volume of interest data of the medical image of FIG. 1.

FIG. 8 is an image, in accordance with the invention, of the image of FIG. 7 combined with the image of FIG. 5.

FIGS. 9a, 9b, 9c and 9d are methods, in accordance with the invention, of providing an image.

### DESCRIPTION OF THE INVENTION

The invention employs a method of forming an image, such as a medical image, showing an object of interest in its anatomical context. For example, the method allows a blood vessel to be seen in its relationship with a bone. In one embodiment, the inventive method includes four steps and involves using the volumetric data of a medical image, such as those provided by a CT or MRI scan. The volumetric data includes volume of interest (VOI) data and volume of context (VOC) data. In one example, the volume of interest data represents the blood vessel and the volume of context data represents the bone.

The present invention provides a non-photorealistic rendering (NPR) technique for rendering the context for objects of interest, which is especially effective when a dark background is used, as is the preference of clinicians. NPR techniques attempt to emulate methods used in forming hand-drawn technical and anatomical illustrations. More information regarding NPR techniques is described in the book “GPU Based Interactive Visualization Techniques”, by Daniel Weiskopf, 2007, p. 191-214, as well as the references cited therein.

The images of the inventive method can be provided in many different color spaces, but an ARGB color space is used herein. In the ARGB color space, A (alpha) represents the opacity of the colors, and RGB represents the intensities of the red, green and blue components of the image pixel, respectively. The components of the color space are normalized between values of zero and one, so that the value ranges of the opacity and red, green and blue colors can have values between zero and one. As the A value is driven to zero and one, the pixel becomes more transparent and opaque, respectively. When an image pixel becomes more opaque, less light can flow through it and when an image pixel becomes more transparent, more light flows through it. As the R value is driven to one and zero, the image pixel becomes more and less red, respectively. As the G value is driven to one and zero, the image pixel becomes more and less green, respectively. As the B value is driven to one and zero, the image pixel becomes more and less blue, respectively.

In one step, a first image is provided by using one of a standard shaded volume rendering technique (SVRT) or Maximum Intensity Projection (MIP) on the VOI data. In another step, a second image is provided using a modified SVRT wherein, while holding the projection geometry unchanged, each virtual ray's opacity is affected by both the VOI and VOC data, but the output image opacity and color include only the VOC contribution to the ray.

In this embodiment, the method includes remapping the colors and the opacity of the second image such that dark edges appear light colored and semi-opaque, while light-colored regions become translucent. In another step, the method includes compositing the second image over the first image, wherein the first image can be seen through the second image.

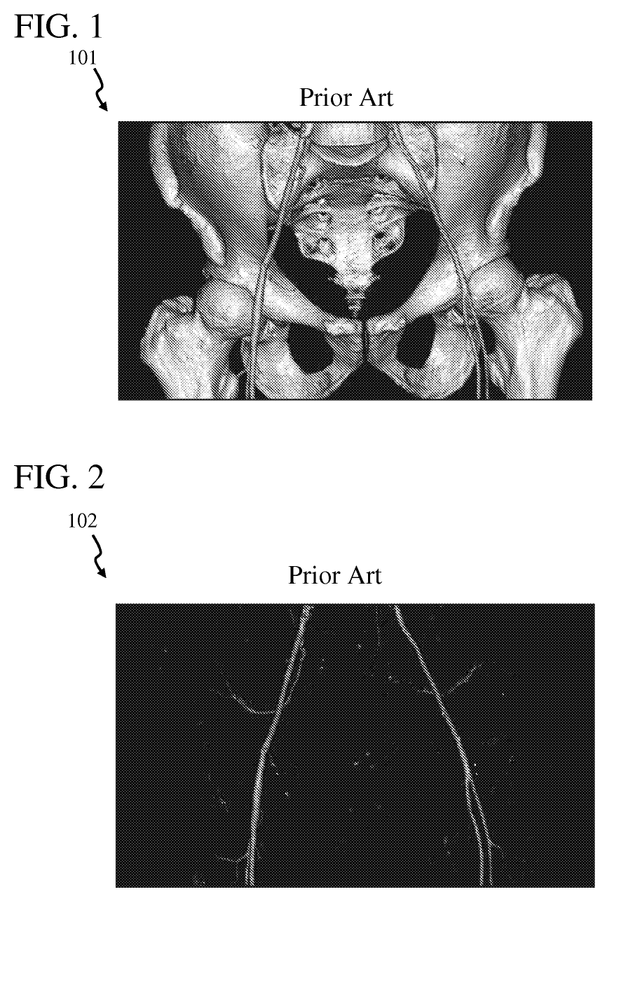

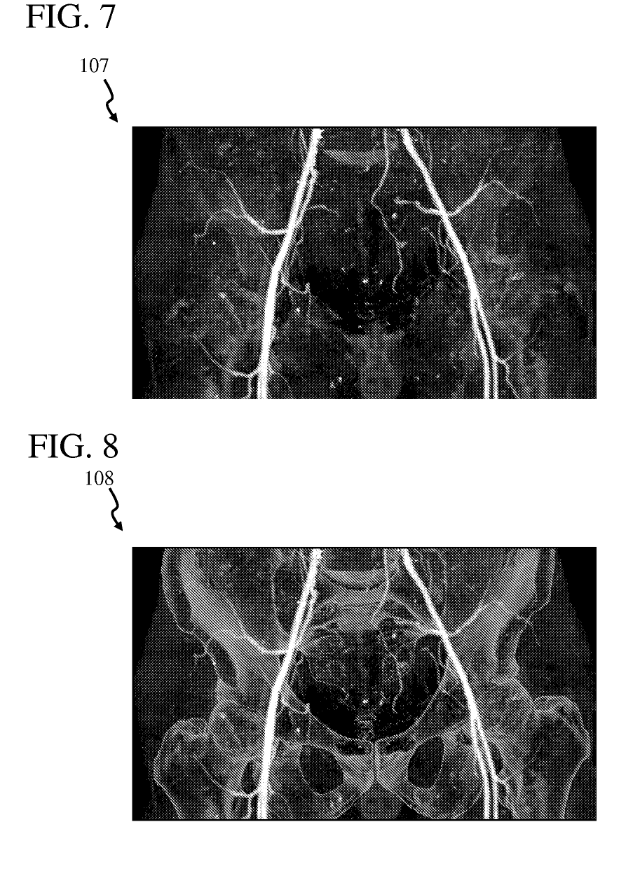

An illustrative example of the inventive method is shown with reference to FIGS. 1-8. The volumetric data of image 101 of FIG. 1 is provided, wherein the volumetric data includes VOI and VOC data. The VOI data corresponds with the blood vessels and the VOC data corresponds with the pelvic bone. The image of the blood vessels is shown in FIG. 2 as image 102, wherein image 102 is provided using SVRT to process the VOI data. It should be noted that, in some embodiments, the VOI data can be processed using a maximum intensity projection (MIP) technique, as represented in an image 107 shown in FIG. 7. As mentioned above, the blood vessels are more visible, but there is no anatomical context because the pelvic bone cannot be seen. Further, images 101 and 107 of FIGS. 2 and 7 lack depth information so that the images look flat. The color space of image 101 of FIGS. 2 and 7 is represented by A1R1G1B1, wherein A1, R1, G1 and B1 represent arrays correspondingly holding the opacity, red, green and blue components of the pixels of FIGS. 2 and 7.

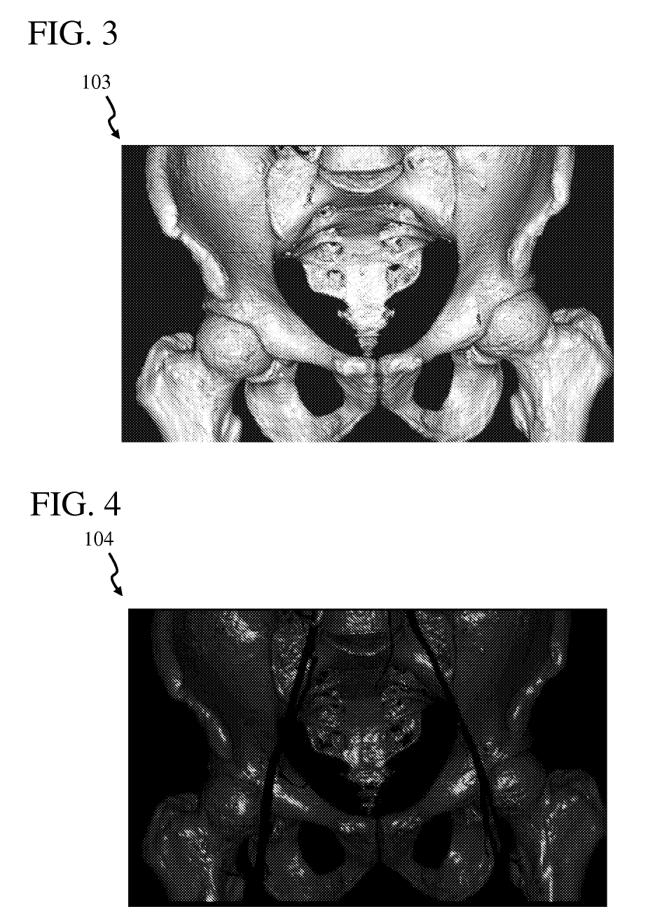

An image 103 of the pelvic bone is shown in FIG. 3, wherein image 103 is provided by applying SVRT to process the VOC data of image 101. In this particular embodiment, image 103 of FIG. 3 is provided by having the SVRT process ignore the VOI data of image 101 (i.e. image 102 of FIG. 2). In response to ignoring the VOI data of image 101, the pelvic bone is more visible in image 103 and the blood vessels are not visible.

FIG. 4 is a modified image 104 of pelvic bone image 103 of FIG. 3. Pelvic bone image 103 of FIG. 3 can be modified in many different ways. In this embodiment, image 104 is formed using a modified SVRT wherein opacity accumulates along the ray both in the VOI and VOC data but the rendered image shown in FIG. 4 includes only the color and opacity accumulated in the VOC data. In other words, the VOI and VOC data is traversed together, as in image 101, but the image generated includes only the color and opacity contribution of the VOC to the image 101. The color space of image 104 of FIG. 4 is represented by A2R2G2B2, wherein A2, R2, G2 and B2 represent the opacity, red, green and blue components of the pixels of FIG. 4.

In this particular example, the transfer function of the VOC data is set to show the pelvic bone in blue in image 104. It should be noted, however, that the transfer function of the VOC data can be set to show the pelvic bone in another color, such as red or green, or a combination of these colors.

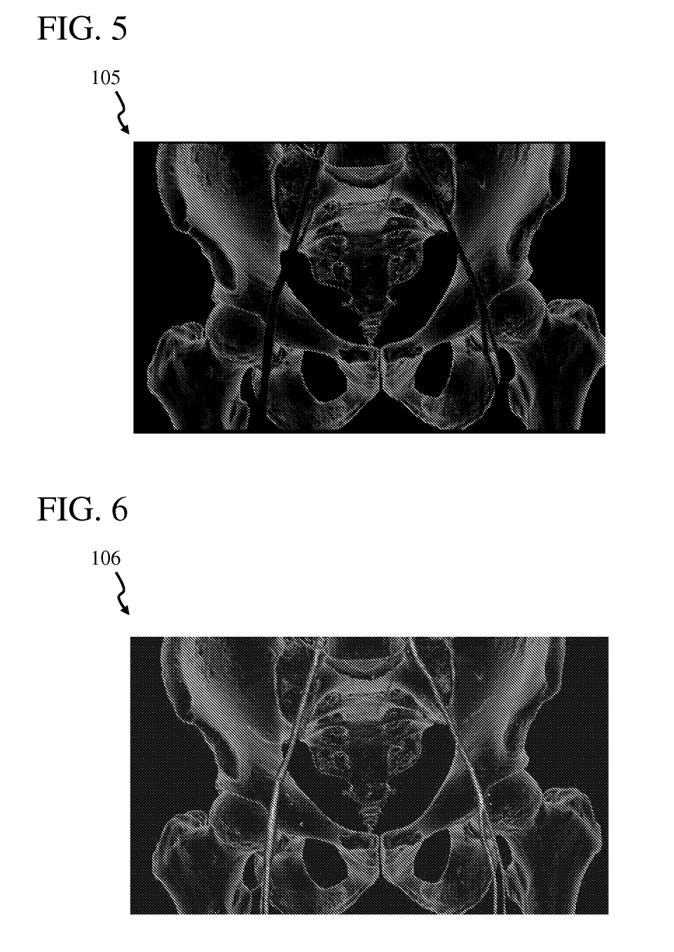

FIG. 5 is an image 105 of the modified image of FIG. 4 after its intensity and pixel opacity have been adjusted. The intensity and pixel opacity of the image 104 of FIG. 4 can be adjusted in many different ways. In this particular example, the intensity of image 104 is inverted (dark<->bright) and the opacity of image 104 is scaled by the inverted intensity. Hence, the darker VOC intensities of image 104 contribute less and the brighter VOC intensities of image 104 contribute more to the resulting composited image 106.

The color space of image 105 of FIG. 5 is represented by A3R3G3B3, wherein A3, R3, G3 and B3 represent the opacity, red, green and blue components of the pixels of FIG. 5. In this example, the values of A3, R3, G3 and B3 are determined from the values of A2, R2, G2 and B2 by the following relations:

I=1.0−B2

R3=I, G3=I, B3=I

A3=A2×I

It should be noted that I represents the modified intensity, which depends on the B2 color value. However, it can depend on other color values, such as the R2 and G2 color values, if desired. The I value can also depend on a weighted sum of the R2, G2 and B2 color values and can be inverted using division, rather than subtraction. It is also possible to differently scale the intensity of each output color component to generate a context color other than white.

In accordance with the invention, image 105 of the VOC is combined with image 101 or 107 of the VOI. In one example, image 105 of FIG. 5 is combined with image 101 of FIG. 2, to provide an image 106 of FIG. 6. In another example, image 105 of FIG. 5 is combined with image 107 of FIG. 7, to provide an image 108 of FIG. 8.

Images 102 and 107 of FIGS. 2 and 7 can be combined with image 105 of FIG. 5 in many different ways. In one example, the modified context image values A3R3G3B3 of image 105 are composited over the VOI image values A1R1G1B1 of image 101 using one of the standard compositing formulas, such as:

R=R1×(1−A3)+R3×A3

G=G1×(1−A3)+G3×A3

B=B1×(1−A3)+B3×A3

A=A1×(1−A3)+A3×A3

It should be noted that by reordering terms of the above equations it is possible to produce identical, or very similar, results using altered computation steps. Such reordering may lead to more efficient implementation on certain computer hardware configurations. For example, images 102 and 103 can be provided concurrently by computing A1R1G1B1 and A2R2G2B2 while traversing the same ray path. Further, image 105 can be provided directly from the volumetric data, without the intermediate step of forming image 104, by accordingly modifying the operations performed during ray traversal. Hence, the images of the invention can be provided faster and with less computing power in certain computer architectures.

Images 106 and 108 of FIGS. 6 and 8 show both the blood vessels and the pelvic bone, wherein the blood vessels behind the pelvic bone can be seen because the pelvic bone is transparent. In this way, the blood vessels are not occluded by the pelvic bone. Further, images 106 and 108 of FIGS. 6 and 8 show depth information so that the location of the blood vessels in relation to the pelvic bone can be seen. In this way, the relationship between the blood vessels and the surrounding bones are easily observed, and the visibility of the blood vessels is nearly as good as when no bone is present.

In one embodiment, image 106 of FIG. 6 is provided by positioning image 105 of FIG. 5 over image 101 of FIG. 2. In this way, image 101 of FIG. 2 can be seen through image 105 of FIG. 5. Further, image 108 of FIG. 8 is provided by positioning image 105 of FIG. 5 over image 107 of FIG. 7. In this way, image 107 of FIG. 7 can be seen through image 105 of FIG. 5.

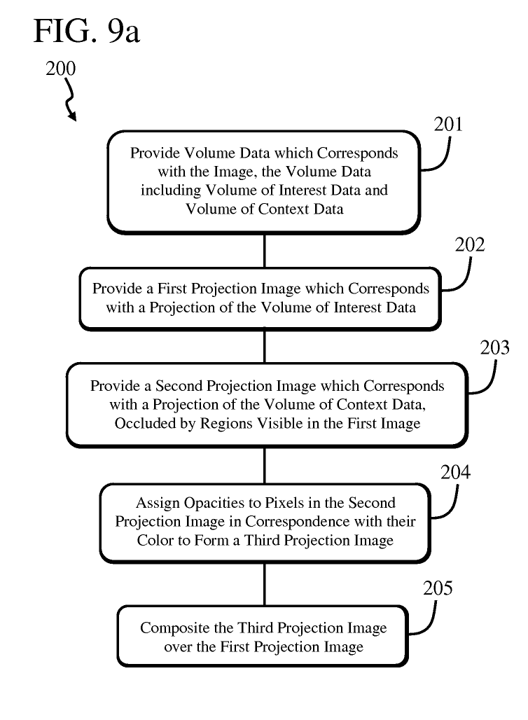

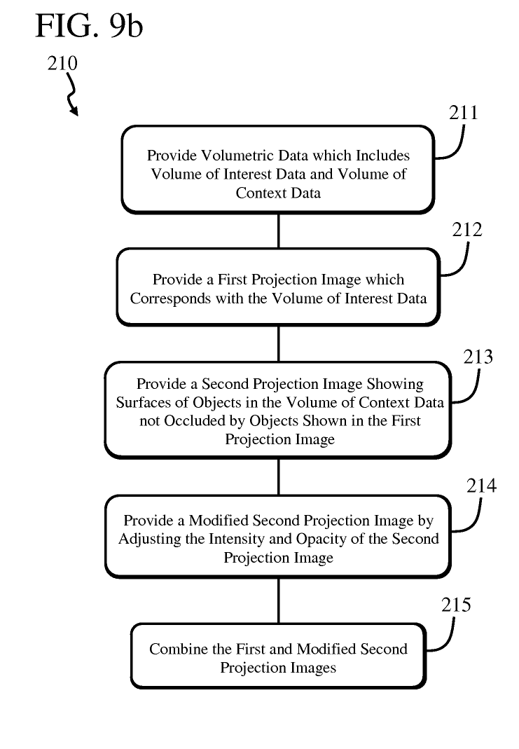

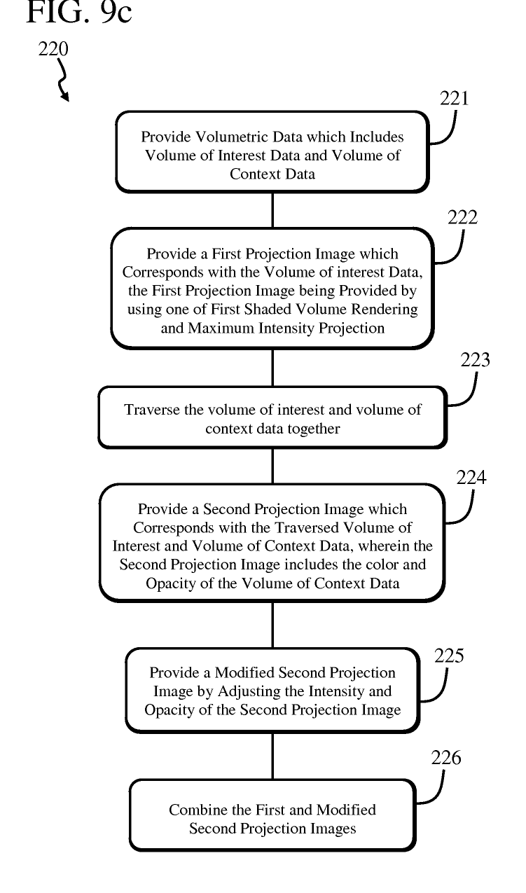

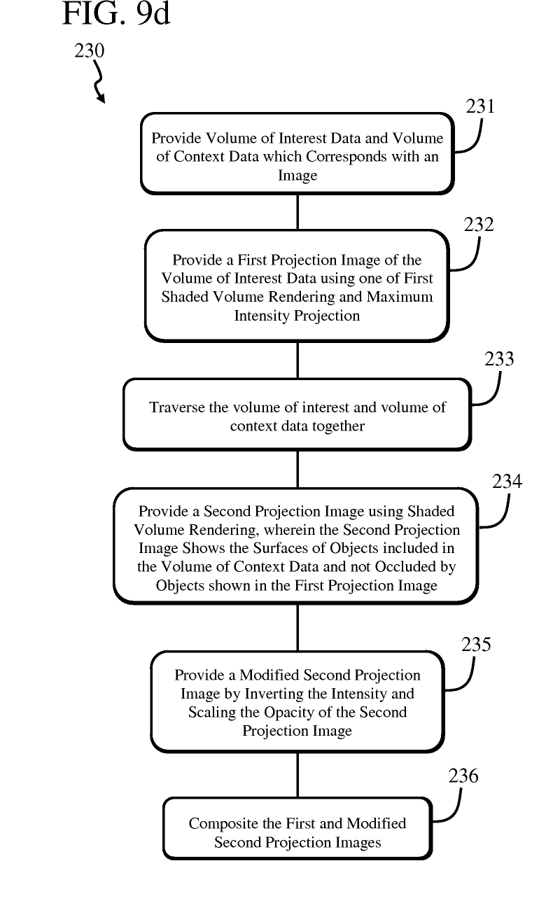

FIG. 9a is a block diagram of a method 200, in accordance with the invention, of providing an image. In this embodiment, method 200 includes a step 201 of providing volume data which corresponds with the image, wherein the volume data includes volume of interest data and volume of context data. The image can be of many different types, but, in this embodiment, it is a medical image, which shows different features of a patient's body, and the volume data is obtained using a medical scanner, such as a Computer Tomography (CT) scanner or a Magnetic Resonance Imaging (MRI) scanner. The boundaries of the volume of interest (VOI) and volume of context (VOC) are obtained previous to activating method 200 using automated and/or manual segmentation methods, as is known in the art.

Method 200 includes a step 202 of providing a first projection image which corresponds with the volume of interest data. The first projection image is provided to show the shape and/or spatial arrangement of objects using one of known methods for such presentation, such as shaded volume rendering or Maximum Intensity Projection. Method 200 includes a step 203 of providing a second projection image which corresponds with the volume of context data. The second projection image is generated using the same projection parameters as the first projection image, using a known method for showing the shape and/or spatial arrangement of objects in the VOC, preferably shaded volume rendering, while hiding regions that would be occluded by objects that appear in the first projection image. The second projection image may be advantageously inverted from its usual photorealistic appearance to show bright object edges over a dark background.

Method 200 includes a step 204 of assigning opacities to pixels of the second projection image to form a third projection image. The assignment is based on the color value of the pixel, wherein colors which typically appear at or near structure outlines are assigned a higher opacity than other colors. In the case of an inverted photorealistic image, darker pixels are assigned lower opacity than brighter pixels.

Method 200 includes a step 205 of compositing the third projection image over the first projection image. The third projection image is composited over the first projection image so that pixels in first projection image, showing the volume of interest data, can be easily seen through the transparent pixels of the third projection image, except near structure outline, which are assigned a higher opacity.

FIG. 9b is a block diagram of a method 210, in accordance with the invention, of providing an image. In this embodiment, method 210 includes a step 211 of providing volumetric data which includes volume of interest data and volume of context data and a step 212 of providing a first projection image which corresponds with the volume of interest data. The first projection image can be provided using one of shaded volume rendering and Maximum Intensity Projection.

Method 210 includes a step 213 of providing a second projection image showing surfaces of objects in the volume of context data not occluded by objects shown in the first projection image. In some embodiments, the second projection image is provided using a shaded volume rendering technique. The shaded volume rendering technique can be modified such that opacity accumulates along the projection rays in both the volume of context and volume of interest, and the second projection image includes the color and opacity portion accumulated in the volume of context.

Method 210 includes a step 214 of providing a modified second projection image by adjusting the intensity and opacity of the second projection image. In some embodiments, the modified second projection image is provided by inverting the intensity of the second projection image. The modified second projection image can be provided by multiplying the opacity of the second projection image by the inverted intensity of the second projection image.

Method 210 includes a step 215 of combining the first and modified second projection images. In some embodiments, step 215 of combining the first and modified second projection images includes compositing.

FIG. 9c is a block diagram of a method 220, in accordance with the invention, of providing an image. In this embodiment, method 220 includes a step 221 of providing volumetric data which includes volume of interest data and volume of context data and a step 222 of providing a first projection image which corresponds with the volume of interest data. The first projection image is provided by using one of first shaded volume rendering and Maximum Intensity Projection. Method 220 includes a step 223 of traversing the volume of interest and volume of context data together and a step 224 of providing a second projection image which corresponds with the traversed volume of interest and volume of context data, wherein the second projection image includes the color and opacity of the volume of context data. The second projection image is typically provided using shaded volume rendering.

Method 220 includes a step 225 of providing a modified second projection image by adjusting the intensity and opacity of the second projection image. The intensity of the second projection image can be adjusted by adjusting the intensity of the color values included therein. The modified second projection image can be provided by scaling the opacity of the second projection image.

Method 220 includes a step 226 of combining the first and modified second projection images. Step 226 of combining the first and modified second projection images can include increasing the contrast between them. The contrast between the first and modified second projection images can be increased by driving the color of the first and modified second projection images to first and second color values, respectively. The second color value is typically one of red, green and blue, or a combination thereof.

FIG. 9d is a block diagram of a method 230, in accordance with the invention, of providing an image. In this embodiment, method 230 includes a step 231 of providing volume of interest data and volume of context data which corresponds with an image and a step 232 of providing a first projection image of the volume of interest data using one of first shaded volume rendering and maximum intensity projection. Method 230 includes a step 233 of traversing the volume of interest and volume of context data together and a step 234 of providing a second projection image using shaded volume rendering, wherein the second projection image shows the surfaces of objects included in the volume of context data and not occluded by objects shown in the first projection image. The shaded volume rendering technique can be modified such that opacity accumulates along the projection rays in both the volume of context and volume of interest, and the second projection image includes only the color and opacity accumulated in the volume of context.

Method 230 includes a step 235 of providing a modified second projection image by inverting the intensity and scaling the opacity of the second projection image and a step 236 of compositing the first and modified second projection images. The modified second projection image can be provided by accumulating the opacity along the projection rays in the volume of context and volume of interest. The modified second projection image typically includes the color and opacity accumulated in the volume of context. The step of inverting the intensity of the second projection image can include adjusting the intensity of the color values included therein. The opacity of the second projection image can be scaled by multiplying the opacity of the second projection image by the inverted intensity of the second projection image.

The embodiments of the invention described herein are exemplary and numerous modifications, variations and rearrangements can be readily envisioned to achieve substantially equivalent results, all of which are intended to be embraced within the spirit and scope of the invention.

1. A method of providing an image, comprising:
providing volumetric data which includes volume of interest data and volume of context data;
providing a first projection image which corresponds with the volume of interest data;
providing a second projection image showing surfaces of objects in the volume of context data not occluded by objects shown in the first projection image;
providing a modified second projection image by adjusting the intensity and opacity of the second projection image; and
combining the first and modified second projection images.

2. The method of claim 1, wherein the first projection image is provided using one of shaded volume rendering and Maximum Intensity Projection.

3. The method of claim 1, wherein the second projection image is provided using a shaded volume rendering technique.

4. The method of claim 3, wherein the shaded volume rendering technique is modified such that opacity accumulates along the projection rays in both the volume of context and volume of interest, and the second projection image includes the color and opacity portion accumulated in the volume of context.

5. The method of claim 1, wherein the modified second projection image is provided by inverting the intensity of the second projection image.

6. The method of claim 1, wherein the modified second projection image is provided by multiplying the opacity of the second projection image by the inverted intensity of the second projection image.

7. The method of claim 1, wherein the step of combining the first and modified second projection images includes compositing.

8. A method of providing an image, comprising:
providing volumetric data which includes volume of interest data and volume of context data;
providing a first projection image which corresponds with the volume of interest data, the first projection image being provided by using one of first shaded volume rendering and Maximum Intensity Projection;
traversing the volume of interest and volume of context data together;
providing a second projection image which corresponds with the traversed volume of interest and volume of context data, wherein the second projection image includes the color and opacity of the volume of context data;
providing a modified second projection image by adjusting the intensity and opacity of the second projection image; and
combining the first and modified second projection images.

9. The method of claim 8, wherein the second projection image is provided using shaded volume rendering.

10. The method of claim 8, wherein the step of providing the modified second projection image includes scaling the opacity of the second projection image.

11. The method of claim 8, wherein the step of adjusting the intensity of the second projection image includes adjusting the intensity of the color values included therein.

12. The method of claim 8, wherein the step of combining the first and modified second projection images includes increasing the contrast between them.

13. The method of claim 12, wherein the contrast between the first and modified second projection images is increased by driving the color of the first and modified second projection images to first and second color values, respectively.

14. The method of claim 13, wherein the second color value is one of red, green and blue, or a combination thereof.

15. A method, comprising:
providing volume of interest data and volume of context data which corresponds with an image;
providing a first projection image of the volume of interest data using one of first shaded volume rendering and maximum intensity projection;
traversing the volume of interest and volume of context data together;
providing a second projection image using shaded volume rendering, wherein the second projection image shows the surfaces of objects included in the volume of context data and not occluded by objects shown in the first projection image;
providing a modified second projection image by inverting the intensity and scaling the opacity of the second projection image; and
compositing the first and modified second projection images.

16. The method of claim 15, wherein the step of inverting the intensity of the second projection image includes adjusting the intensity of the color values included therein.

17. The method of claim 15, wherein the opacity of the second projection image is scaled by multiplying the opacity of the second projection image by the inverted intensity of the second projection image.

18. The method of claim 15, wherein the shaded volume rendering technique is modified such that opacity accumulates along the projection rays in both the volume of context and volume of interest, and the second projection image includes only the color and opacity accumulated in the volume of context.

19. The method of claim 15, wherein the modified second projection image is provided by accumulating the opacity along the projection rays in the volume of context and volume of interest.

20. The method of claim 19, wherein the modified second projection image includes the color and opacity accumulated in the volume of context.
